(19) United States
(12) Patent Application Publication
(10) Pub. No.: US 2022/0004937 A1
(43) Pub. Date: Jan. 6, 2022

(54) DETERMINING APPLICATION PATH FOR EXECUTION BY BOT

(71) Applicant: ABBYY Development Inc., Denver, DE (US)

(72) Inventor: Alex Elkin, Bolton, MA (US)

(21) Appl. No.: 16/919,632

(22) Filed: Jul. 2, 2020

(51) Int. Cl. G06Q 10/02; G06F 9/451; G06Q 10/10

(52) U.S. Cl. CPC G06Q 10/02; G06Q 10/1095; G06F 9/453

(57) ABSTRACT

A method of determining an application path for execution by bot comprises: identifying, by a computer system, a business task to be performed by interacting with one or more applications collectively having a plurality of application states; identifying, among the plurality of application states, an initial application state, an intermediate application state, and a final application state associated with the business task; identifying a plurality of known graphs, wherein each graph of the plurality of known graphs comprises a respective plurality of vertices representing a subset of the plurality of application states, wherein each plurality of vertices comprises a first vertex representing the initial application state, a second vertex representing the intermediate application state, and a third vertex representing the final application state, and wherein each graph of the plurality of graphs comprises at least one relevant path including the first vertex, the second vertex, and the third vertex; determining, based on a plurality of relevant paths comprised by the plurality of graphs, a suitable path satisfying a path selection condition; and performing the business task by utilizing the suitable path.

### TECHNICAL FIELD

The implementations of the disclosure relate generally to computer systems and, more specifically, to systems and methods for creation of software robots.

### BACKGROUND

Software robots (bots) are used to automate various tasks in order to save time and money and/or, increase accuracy of the task performance.

For instance, a software bot can be used to book travel tickets. The bot automatically analyses user's itinerary, determines time and destination of the trip, requests business travel approval from the appropriate authorization system, accesses maps and airline schedules to develop an optimal rout, etc. As another example, software bots can be used to process e-mails, including checking e-mail content and context, triggering action based on these findings, converting and storing attachments in appropriate folders, collecting information necessary for further action on the e-mail, etc.

### SUMMARY OF THE DISCLOSURE

Implementations of the present disclosure describe mechanisms for determining an application path for execution by bot. A method of the disclosure includes: identifying, by a computer system, a business task to be performed by interacting with one or more applications collectively having a plurality of application states; identifying, among the plurality of application states, an initial application state, an intermediate application state, and a final application state associated with the business task; identifying a plurality of known graphs, wherein each graph of the plurality of known graphs comprises a respective plurality of vertices representing a subset of the plurality of application states, wherein each plurality of vertices comprises a first vertex representing the initial application state, a second vertex representing the intermediate application state, and a third vertex representing the final application state, and wherein each graph of the plurality of graphs comprises at least one relevant path including the first vertex, the second vertex, and the third vertex; determining, based on a plurality of relevant paths comprised by the plurality of graphs, a suitable path satisfying a path selection condition; and performing the business task by utilizing the suitable path.

A non-transitory machine-readable storage medium of the disclosure includes instructions that, when accessed by a processing device, cause the processing device to: identifying, by a computer system, a business task to be performed by interacting with one or more applications collectively having a plurality of application states; identifying, among the plurality of application states, an initial application state, an intermediate application state, and a final application state associated with the business task; identifying a plurality of known graphs, wherein each graph of the plurality of known graphs comprises a respective plurality of vertices representing a subset of the plurality of application states, wherein each plurality of vertices comprises a first vertex representing the initial application state, a second vertex representing the intermediate application state, and a third vertex representing the final application state, and wherein each graph of the plurality of graphs comprises at least one relevant path including the first vertex, the second vertex, and the third vertex; determining, based on a plurality of relevant paths comprised by the plurality of graphs, a suitable path satisfying a path selection condition; and performing the business task by utilizing the suitable path.

A system of the disclosure includes a memory, and a processing device operatively coupled to the memory, the processing device to: identifying, by a computer system, a business task to be performed by interacting with one or more applications collectively having a plurality of application states; identifying, among the plurality of application states, an initial application state, an intermediate application state, and a final application state associated with the business task; identifying a plurality of known graphs, wherein each graph of the plurality of known graphs comprises a respective plurality of vertices representing a subset of the plurality of application states, wherein each plurality of vertices comprises a first vertex representing the initial application state, a second vertex representing the intermediate application state, and a third vertex representing the final application state, and wherein each graph of the plurality of graphs comprises at least one relevant path including the first vertex, the second vertex, and the third vertex; determining, based on a plurality of relevant paths comprised by the plurality of graphs, a suitable path satisfying a path selection condition; and performing the business task by utilizing the suitable path.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 is a flow diagram illustrating one exemplary method of determining application path for execution by bot, in accordance with some implementations of the present disclosure.

FIG. 2 illustrates a block diagram of an example computer system in accordance with some implementations of the present disclosure.

FIG. 3 illustrates a block diagram of an example computer system in accordance with some implementations of the present disclosure.

FIG. 4 schematically illustrates a structure of an example neural network operating in accordance with one or more aspects of the present disclosure.

### DETAILED DESCRIPTION

Software robots (bots) are usually created to perform various business tasks, such as scheduling meetings, booking travel tickets, responding to routine correspondence, and others. Such business tasks may include multiple steps, performed by the same or different applications. These applications may include an e-mail client (such as Outlook, Thunderbird, Windows Mail), word-processing applications (such as Microsoft Word, WordPerfect, AppleWorks, OpenOffice), image-processing applications (such as FineReader, FlexiCapture, Adobe Acrobat, OmniPage), etc. These applications may be web-based applications or desktop applications.

Steps of these business tasks may comprise receiving data from one or more users, retrieving data from one or multiple applications, providing data to one or multiple applications, performing calculations based on the data, initiating next step in the task based on the data or based, providing data to a particular user, etc.

In some implementations, the step of receiving data from a user may be performed by a chat bot or a voice-controlled bot.

Standard system of creating software bots includes creating a detailed application model. Application model is a directed graph in which vertices represent application states and edges represent possible transitions between these application states. A software bot, using this application model, creates a path through the directed graph from the starting application state to the end point while visiting all necessary intermediate states. When the path comes to a fork, it is expected that the application model includes complete rules for software bot to determine what the next step should be. Based on the specific task information available to the bot at the fork and the rules the bot derives from the application model, it calculates its further path.

Application modes are usually extremely detailed. If these models are expected to operate reliably, they must include specific description of any possible outcome of every application step. Accordingly, application models are usually cumbersome, require significant time and effort in their building, are often incomplete, and need qualified personnel to correct them any time a company adjusts its business processes. The present application is intended to address these drawbacks of application model approach to software bot creation.

The present invention is directed to a novel approach for creating software bots engineered to perform business tasks using existing graphs of application states and corresponding execution paths.

A graph of application states is a directed graph consisting of multiple vertices, each vertex representing an application state. An application state defines the current condition and the location of the computer application with which a user interacts. In general, an application state is defined by the application controls, including but not limited to: buttons, fields, labels, and their respective states and values.

In some implementations, the graph of application states includes application states from multiple applications. For example, a graph of application state corresponding to a business task of processing incoming mail may include application states from a mail client application (for receiving messages), a document management application (for storing attachments), an image processing application (for processing images in a message), etc.

The vertices of the graph of application states are connected by edges where each edge represents a possible transition between the vertices connected by the edge. In other words, when one edge connects a first vertex to a second vertex, it possible to transition from an application state represented by the first vertex to an application state represented by the second vertex during an execution of a business task executed based on this graph.

A software bot for a particular business task is created by constructing an execution path for this business task on a graph of application states.

An execution path of a business task is a sequence of vertices and edges of a graph of application states. It specifies in what order steps of the business task are performed. An execution path has a root vertex representing the initial application state of the business task, one or more end vertices representing respective possible final application states of the business task, and intermediate vertices, representing possible intermediate application states of the business task (i.e., application states that lay on a path between the initial state and a final state).

In some implementation of the present invention, a library of graphs of application states is compiled. Each graph of the library comprises at least one execution path of one or more business tasks. Such library may contain multiple graphs with multiple paths for performing the same or similar business tasks. In some implementations graphs for the library are created by collecting historical data of user-performed tasks in an organization or multiple organizations. In some implementations of the present disclosure such historical data is collected using data capture software (for example, ABBYY Timeline) which communicates with the application in order to observe the application execution and to record valid application state transitions thus forming a plurality of graphs representing respective historical application paths. In some implementations, earlier created application models (i.e., software modules that simulate the application state transitions without implementing the internal application logic) are used. In some implementations, both historical application paths and existing application model paths are present in the library.

In some implementations of the present disclosure, the library of graphs of application states comprises additional information for at least some of the graphs and execution paths in the library. In some implementations, this additional information may include historical data for prior use of a particular graph in the library, including particulars of the entity that created the graph, a number of times particular execution path of the graph has been executed, information regarding entities that have been executing this path, level of satisfaction of the entities that have been executing this path in the past, number of successful executions of the path, etc.

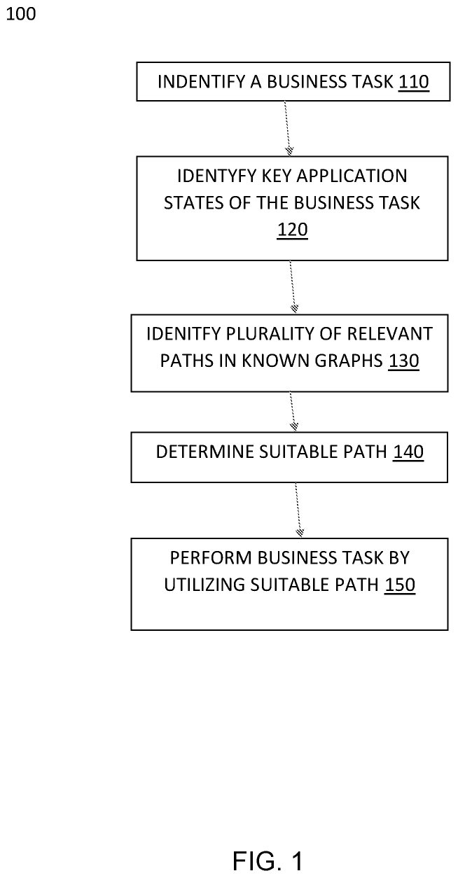

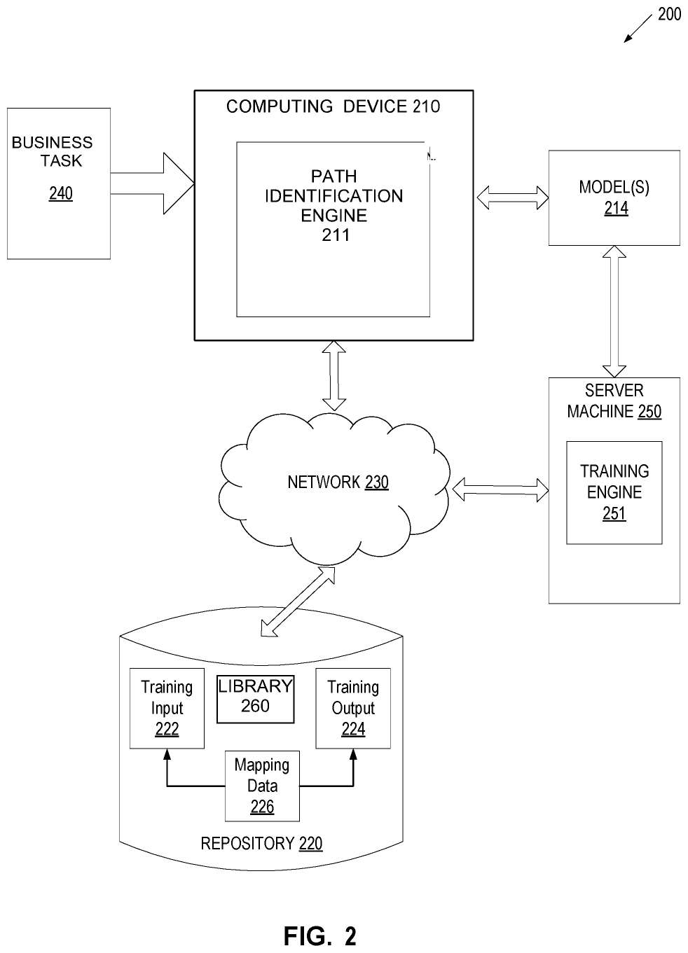

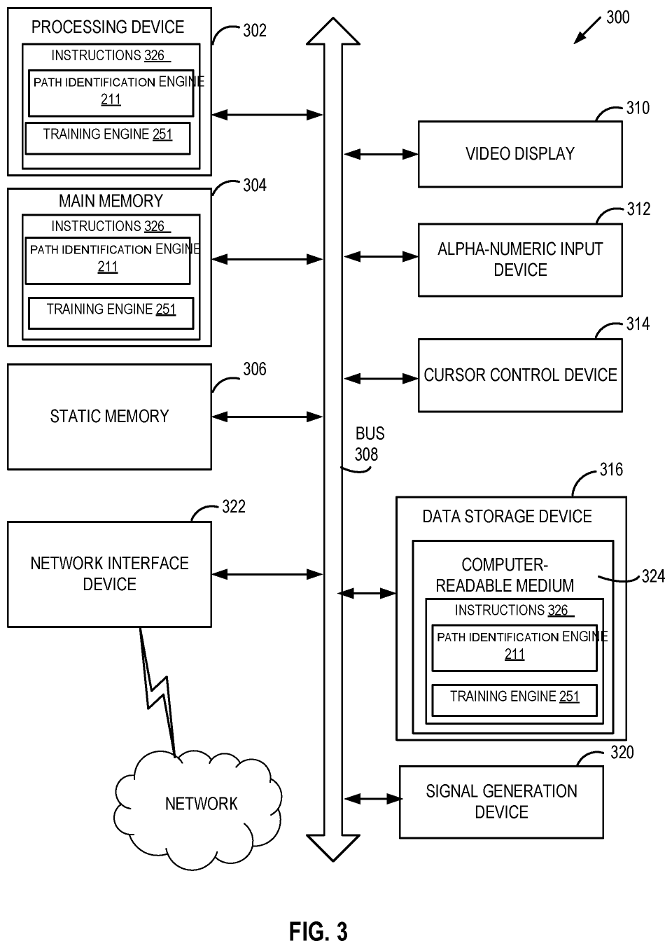

FIG. 1 is a flow diagram illustrating exemplary method 100 of selecting a suitable path for performing a business task by a software bot, in accordance with some implementations of the present disclosure. Method 100 may be performed by processing logic that may comprise hardware (e.g., circuitry, dedicated logic, programmable logic, microcode, etc.), software (such as instructions run on a processing device), firmware, or a combination thereof. In one implementation, method 100 may be performed by a processing device (e.g. a processing device 302 of FIG. 3) of a computing device 210 and/or a server machine 250 as described in connection with FIG. 2. In certain implementations, method 100 may be performed by a single processing thread. Alternatively, method 100 may be performed by two or more processing threads, each thread executing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other. Therefore, while FIG. 1 and the associated descriptions list the operations of method 100 in certain order, various implementations of the methods may perform at least some of the described operations in parallel and/or in arbitrary selected orders.

At block 110, the processing device performing method 100 may identify the business task to be performed by the new software bot. The business task may be identified by providing at least some of the steps to be performed in this business task (e.g., receiving incoming electronic mail by a mail client application, storing attachments found in the received messages by a document management application, and processing images found in the attachments by an processing application (such as an optical character recognition (OCR), image classification, pattern detection, etc.). In some implementations of the present disclosure, all steps of the business task are identified. In some implementations of the present disclosure, additional information regarding the business task is also provided. Such information may include information of a particular entity this business task is developed for. In some implementations, the entity information may include the record of other software bots used by this entity in the past, particular industry type, geographic location, organization size, and other pertinent information for this entity.

At block 120, the processing device performing method 100 may identify one or more key application states for the business task identified in block 110. A key application state is an application state that is required to be visited in order to perform the business task.

Next, at block 130, the processing device analyzes the library of graphs of application states in order to identify a set of graphs having execution paths that include vertices corresponding to all key applications states of our business task as they were identified in block 120. If no such graph is found the processing device identifies closest available graphs, e.g. graphs with the same final state as the business task, graphs that include the same software applications as the business task, etc.

Multiple paths, containing these key application states may be identified in this step. As a result, in the next block 140 the processing device may determine the suitable path amongst the paths identified in block 130 by analyzing and comparing them to each other.

A number of parameters may be used to determine the suitable path. In some implementations of the present invention a suitability measure is determined for one or more of relevant paths.

In some implementations of the present disclosure, historical information of the paths, identified in block 130, may be used to determine the suitability measure of one or more relevant paths. In these instances, this historical information is compared with the available information of the business task to be performed.

In some implementations, the path suitability measure may reflect similarity between the entity that created a particular business path and the entity for whom the business task is being developed. This similarity measure may be based on respective industry, size, geographic location, of these entities, etc. For example, each entity may be represented by a vector of numeric features (e.g., the industry identifier, the entity size, the geographic location identifier), and the similarity measure of two entities may be represented by the Euclidian distance between their respective vectors.

In some implementations of the present disclosure, the path suitability measure may reflect a historical use parameter, which may be calculated for one of more of the paths identified in block 130. Such historical use parameter may comprise the number of times this particular path has been executed by the entity for whom the business task is being developed.

In some implementations of the present disclosure, the path suitability measure may reflect a frequency parameter, which may be calculated for one or more of the paths identified in block 130. This frequency parameter may comprise the number of times the path in question has been executed in the past. In some implementations, this parameter comprised the number of times this path has been executed with the level of user satisfaction exceeding a predetermined threshold.

In some implementations of the present disclosure, the path suitability measure may reflect a volatility measure, which may be determined for one or more of the paths, identified in block 130. In some implementations, the volatility measure may comprise the number of possible variations in the path, i.e. the number of forks down the path that implement conditionally-selectable sub-paths. In some implementations, the volatility measure may comprise the number of edges that comprise the path.

The above-listed measures and parameters, as well as other parameters, may be used, alone or in combination, to determine the suitable path from the set of relevant paths, identified in block 130. In an illustrative example, the path suitability measure may be represented by a weighted sum of one or more above-described metrics.

In some implementations of the present disclosure, the suitable path is determined using artificial intelligence. Such determination may involve training a neural network to determine suitable path based on a set of relevant paths.

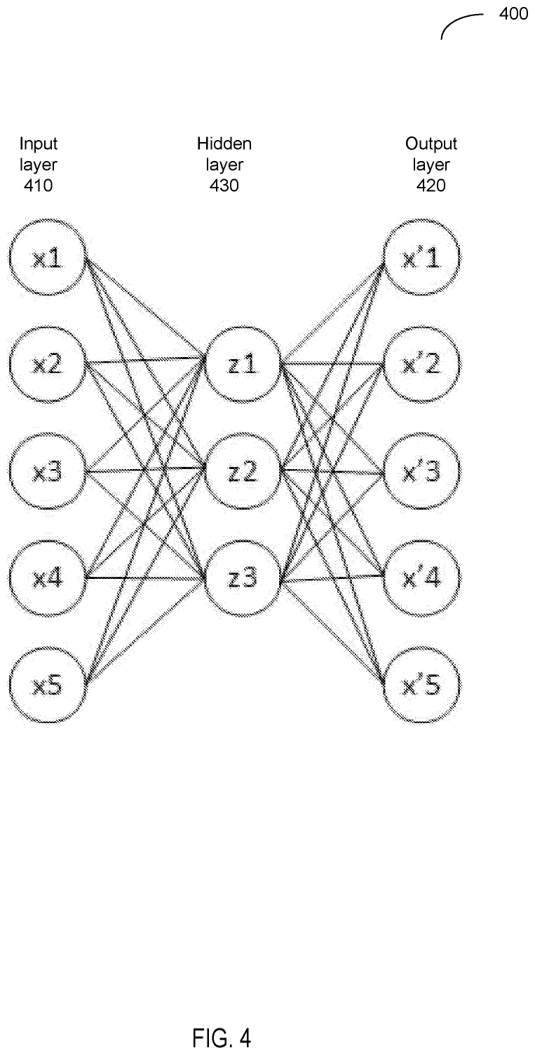

FIG. 4 schematically illustrates a structure of a neural network operating in accordance with one or more aspects of the present disclosure. As shown in FIG. 4, the neural network 400 may be represented by a feed-forward, non-recurrent neural network including an input layer 410, an output layer 420 and one or more hidden layers 430 connecting the input layer 410 and the output layer 420. The output layer 420 may have the same number of nodes as the input layer 410, such that the network 400 may be trained, by an unsupervised learning process, to reconstruct its own inputs.

The neural network may include multiple neurons that are associated with learnable weights and biases. The neurons may be arranged in layers. The neural network may be trained on a training dataset of paths that contain known edges and vertices. For example, the training data set may include examples of paths containing one or more paths as training inputs and one or more paths that have been determined to be the suitable as training outputs.

The neural network may generate an observed output for each training input. During training of the neural network, the parameters of the neural network may be adjusted to optimize prediction accuracy. Training the neural network may involve processing, by the neural network, a set of relevant paths for a given business task, such that the network would identify the best path (i.e., the observed output) among the set of relevant paths, and comparing the identified best path with the known best path (i.e., the training output corresponding to the target input as specified by the training data set). The observed output of the neural network may be compared with the training output, and the error may be propagated back to the previous layers of the neural network, whose parameters (e.g., the weights and biases of the neurons) may be adjusted accordingly in order to minimize the loss function (i.e., the difference between the observed output and the training output).

Once trained, the neural network may be used for automatic detection of the suitable path in a set of relevant paths. The use of neural networks may prevent the need for manual selection of suitability measures for determination of the suitable path. The mechanisms described herein to determine the suitable path may improve the quality of software bot generation process by performing determination of the suitable path using a trained neural network in a way that takes into account a context of the entire path.

At block 150, the business task is executed utilizing the best suitable path, which has been determined in block 140.

In some implementations of the present disclosure, after the business task is executed utilizing the suitable path of block 140, the path and its execution data are added to the library of graphs of application states, and the suitability measures are recalculated when the business task is executed again.

In some implementations, the method 100 comprises determining current application state of the system performing the business task. This current state is added to the set of key application states in order to determine the set of relevant paths.

In some implementations of the present disclosure multiple suitable paths are identified by the method 100 using the suitability measure. In some implementations these multiple suitable paths are presented to a user who identified which of them is executed at block 150 of the present method 100.

FIG. 2 is a block diagram of an example computer system 200 in which implementations of the disclosure may operate. As illustrated, system 200 can include a computing device 210, a repository 220, and a server machine 250 connected to a network 230. Network 230 may be a public network (e.g., the Internet), a private network (e.g., a local area network (LAN) or wide area network (WAN)), or a combination thereof.

The computing device 210 may be a desktop computer, a laptop computer, a smartphone, a tablet computer, a server, a scanner, or any suitable computing device capable of performing the techniques described herein. In some implementations, the computing device 210 can be (and/or include) one or more computing devices 300 of FIG. 3.

A business task 240 may be received by the computing device 210. The business task 240 may include any suitable steps, including receiving data from one or more users, retrieving data from one or multiple applications, providing data to one or multiple applications, performing calculations based on the data, initiating next step in the task based on the data or based, providing data to a particular user, etc.

The business task 240 may be received in any suitable manner. For example, the computing device 210 may receive a list of steps of business task 240. Additionally, in instances where the computing device 210 is a server, a client device connected to the server via the network 230 may upload a business task 240 to the server. In instances where the computing device 210 is a client device connected to a server via the network 230, the client device may download the business task 240 from the server or from the repository 220.

The business task 240 may be used to train a set of machine learning models or may be a new business task for which suitable path detection is desired.

In one implementation, computing device 210 may include a suitable path identification engine 211. The suitable path identification engine 211 may include instructions stored on one or more tangible, machine-readable storage media of the computing device 210 and executable by one or more processing devices of the computing device 210.

In one implementation, the suitable path identification engine 211 may use a set of trained machine learning models 214 to detect one or more suitable paths in a library of graphs of application states 260. The library of graphs of application states may be stored in a repository 220. The machine learning models 214 are trained and used to identify suitable paths.

The suitable path identification engine 211 may be a client-based application or may be a combination of a client component and a server component. In some implementations, the suitable path identification engine 211 may execute entirely on the client computing device such as a server computer, a desktop computer, a tablet computer, a smart phone, a notebook computer, a camera, a video camera, or the like. Alternatively, a client component of suitable path identification engine 211 executing on a client computing device may receive a business task and transmit it to a server component of the suitable path identification engine 211 executing on a server device that performs the suitable path identification. The server component of the suitable path identification engine 211 may then return an identified suitable path to the client component of the suitable path identification engine 211 executing on the client computing device for storage. Alternatively, the server component of the suitable path identification engine 211 may provide an identification result to another application. In other implementations, suitable path identification engine 211 may execute on a server device as an Internet-enabled application accessible via a browser interface. The server device may be represented by one or more computer systems such as one or more server machines, workstations, mainframe machines, personal computers (PCs), etc.

Server machine 250 may be and/or include a rackmount server, a router computer, a personal computer, a portable digital assistant, a mobile phone, a laptop computer, a tablet computer, a camera, a video camera, a netbook, a desktop computer, a media center, or any combination of the above. The server machine 250 may include a training engine 251. The training engine 251 can construct the machine learning model(s) 214 for suitable path detection. The machine learning model(s) 214, as illustrated in FIG. 2, may be trained by the training engine 251 using training data that includes training inputs and corresponding training outputs (correct answers for respective training inputs). The training engine 251 may find patterns in the training data that map the training input to the training output (the answer to be predicted) and provide the machine learning models 214 that capture these patterns. The set of machine learning models 214 may be composed of, e.g., a single level of linear or non-linear operations (e.g., a support vector machine (SVM)) or may be a deep neural network, e.g., a machine learning model that is composed of multiple levels of non-linear operations. Examples of deep neural networks are neural networks including convolutional neural networks, recurrent neural networks (RNN) with one or more hidden layers, and fully connected neural networks. In some implementations, the machine learning models 214 may include one or more neural networks as described in connection with FIG. 1.

The machine learning models 214 may be trained to identify one or more suitable paths for a business task 240. The training data may be stored in the repository 220 and may include one or more training inputs 222 and one or more training outputs 224. The training data may also include mapping data 226 that maps the training inputs 222 to the training outputs 224. During the training, the training engine 251 can find patterns in the training data 226 that can be used to map the training inputs to the training outputs. The patterns can be subsequently used by the machine learning model(s) 214 for future predictions. For example, upon receiving an input of unknown business task, the trained machine learning model(s) 214 may predict a suitable path for this business task and may provide such suitable path as an output.

The repository 220 may be a persistent storage capable of storing structures to perform path detection in accordance with implementations of the present disclosure. The repository 220 may be hosted by one or more storage devices, such as main memory, magnetic or optical storage based disks, tapes or hard drives, NAS, SAN, and so forth. Although depicted as separate from the computing device 210, in an implementation, the repository 220 may be part of the computing device 210. In some implementations, repository 220 may be a network-attached file server, while in other implementations content repository 220 may be some other type of persistent storage such as an object-oriented database, a relational database, and so forth, that may be hosted by a server machine or one or more different machines coupled to the via the network 230.

FIG. 3 depicts an example computer system 300 which can perform any one or more of the methods described herein. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 300 includes a processing device 302, a main memory 304 (e.g., read-only memory (ROM), flash memory, dynamic random access memory (DRAM) such as synchronous DRAM (SDRAM)), a static memory 306 (e.g., flash memory, static random access memory (SRAM)), and a data storage device 316, which communicate with each other via a bus 308.

Processing device 302 represents one or more general-purpose processing devices such as a microprocessor, central processing unit, or the like. More particularly, the processing device 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 302 may also be one or more special-purpose processing devices such as an application specific integrated circuit (ASIC), a field programmable gate array (FPGA), a digital signal processor (DSP), network processor, or the like. The processing device 302 is configured to execute instructions 326 for implementing the suitable path identification engine 211 and/or the training engine 251 of FIG. 2 and to perform the operations and steps discussed herein (e.g., method 100 of FIG. 1).

The computer system 300 may further include a network interface device 322. The computer system 300 also may include a video display unit 310 (e.g., a liquid crystal display (LCD) or a cathode ray tube (CRT)), an alphanumeric input device 312 (e.g., a keyboard), a cursor control device 314 (e.g., a mouse), and a signal generation device 320 (e.g., a speaker). In one illustrative example, the video display unit 310, the alphanumeric input device 312, and the cursor control device 314 may be combined into a single component or device (e.g., an LCD touch screen).

The data storage device 316 may include a computer-readable storage medium 324 on which is stored the instructions 326 embodying any one or more of the methodologies or functions described herein. The instructions 326 may also reside, completely or at least partially, within the main memory 304 and/or within the processing device 302 during execution thereof by the computer system 300, the main memory 304 and the processing device 302 also constituting computer-readable media. In some implementations, the instructions 326 may further be transmitted or received over a network via the network interface device 322.

While the computer-readable storage medium 324 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method, comprising:
identifying, by a computer system, a business task to be performed by interacting with one or more applications collectively having a plurality of application states;
identifying, among the plurality of application states, an initial application state, an intermediate application state, and a final application state associated with the business task;
identifying a plurality of known graphs, wherein each graph of the plurality of known graphs comprises a respective plurality of vertices representing a subset of the plurality of application states, wherein each plurality of vertices comprises a first vertex representing the initial application state, a second vertex representing the intermediate application state, and a third vertex representing the final application state, and wherein each graph of the plurality of graphs comprises at least one relevant path including the first vertex, the second vertex, and the third vertex;
determining, based on a plurality of relevant paths comprised by the plurality of graphs, a suitable path satisfying a path selection condition; and
performing the business task by utilizing the suitable path.

2. The method of claim 1, wherein the one or more applications comprise at least one of: a desktop application or a browser-based application.

3. The method of claim 1, wherein the path selection condition specifies a path with a highest similarity measure.

4. The method of claim 1, wherein the path selection condition specifies a historical use parameter.

5. The method of claim 1, wherein the path selection condition specifies one or more parameters of the suitable path.

6. The method of claim 1, wherein the path selection condition specifies selecting a suitable path with minimum number of conditionally selectable sub-paths.

7. The method of claim 1, wherein the method is performed by one of: a chat bot or a voice-controlled bot.

8. The method of claim 1, wherein an application state of the plurality of application states comprises an input operation to be performed with respect to an application of the plurality of applications.

9. The method of claim 1, wherein an application state of the plurality of application states comprises an output operation to be performed by an application of the plurality of applications.

10. The method of claim 1, wherein an application state of the plurality of application states specifies a conditional selection of two or more sub-paths comprising to a vertex representing the application state.

11. The method of claim 1, wherein performing the business task further comprises:
modifying the suitable path to produce a modified path; and
appending the modified path to the plurality of graphs.

12. The method of claim 1, wherein determining the suitable path satisfying the path selection condition comprises using a first neural network.

13. A system, comprising:
a memory;
a processor, coupled to the memory, the processor configured to:
identify a business task to be performed by interacting with one or more applications collectively having a plurality of application states;
identify, among the plurality of application states, an initial application state, an intermediate application state, and a final application state associated with the business task;
identify a plurality of known graphs, wherein each graph of the plurality of known graphs comprises a respective plurality of vertices representing a subset of the plurality of application states, wherein each plurality of vertices comprises a first vertex representing the initial application state, a second vertex representing the intermediate application state, and a third vertex representing the final application state, and wherein each graph of the plurality of graphs comprises at least one relevant path including the first vertex, the second vertex, and the third vertex;
determine, based on a plurality of relevant paths comprised by the plurality of graphs, a suitable path satisfying a path selection condition; and
perform the business task by utilizing the suitable path.

14. The system of claim 13, wherein an application state of the plurality of application states comprises an input operation to be performed with respect to an application of the plurality of applications.

15. The system of claim 13, wherein an application state of the plurality of application states comprises an output operation to be performed by an application of the plurality of applications.

16. The system of claim 13, wherein an application state of the plurality of application states specifies a conditional selection of two or more sub-paths comprising to a vertex representing the application state.

17. The system of claim 13, wherein performing the business task further comprises:
modifying the suitable path to produce a modified path; and
appending the modified path to the plurality of graphs.

18. A non-transitory computer-readable storage medium comprising executable instructions that, when executed by a computer system, cause the computer system to:
identify a business task to be performed by interacting with one or more applications collectively having a plurality of application states;
identify, among the plurality of application states, an initial application state, an intermediate application state, and a final application state associated with the business task;
identify a plurality of known graphs, wherein each graph of the plurality of known graphs comprises a respective plurality of vertices representing a subset of the plurality of application states, wherein each plurality of vertices comprises a first vertex representing the initial application state, a second vertex representing the intermediate application state, and a third vertex representing the final application state, and wherein each graph of the plurality of graphs comprises at least one relevant path including the first vertex, the second vertex, and the third vertex;
determine, based on a plurality of relevant paths comprised by the plurality of graphs, a suitable path satisfying a path selection condition; and
perform the business task by utilizing the suitable path.

19. The non-transitory computer-readable storage medium of claim 18, wherein an application state of the plurality of application states comprises an input operation to be performed with respect to an application of the plurality of applications.

20. The non-transitory computer-readable storage medium of claim 18, wherein an application state of the plurality of application states comprises an output operation to be performed by an application of the plurality of applications.
